(19) United States
(12) Patent Application Publication
(10) Pub. No.: US 2006/0042156 A1
(43) Pub. Date: Mar. 2, 2006

(54) Apparatus and method for surfacing earthworms

(76) Inventor: Jim Holland, New Caney, TX (US)

Correspondence Address: ROBERT W STROZIER, P.L.L.C, PO BOX 429, BELLAIRE, TX, 77402-0429, US

(21) Appl. No.: 10/930,052

(22) Filed: Aug. 30, 2004

(51) Int. Cl. A01M 3/00; A01M 17/00

(52) U.S. Cl. 43/132.1

(57) ABSTRACT

An apparatus for surfacing earthworms from an earthworm bearing soil is disclosed including a first member having a plurality of spaced apart notches and a second member, where a bottom end the of the first member is designed to be placed on a surface of site of the earthworm bearing soil and the second member is designed to be rubbed across the notched surface of the first member producing vibrations that surface earthworms. An electronic or electrical version of the apparatus is also disclosed along with methods for using the apparatuses to surface earthworm for harvesting.

### BACKGROUND OF THE INVENTION

1. Field of the Invention

The present invention relates to an apparatus for surfacing earthworm and to methods for making and using same.

More particularly, the present invention relates to an apparatus for surfacing earthworm including a hollow pipe having a plurality of spaced apart notches disposed on one side of the hollow pipe and an external member designed to be passed up and down across notched surface to produce a vibration when place on soil containing earthworms. The invention also relates to a method for making the apparatus and a method for surfacing earthworms using the apparatus.

2. Description of the Related Art

Generally, when a fisherman or fisherwoman needs earthworm for fishing, he/she must spend considerable time in the hit or miss process of digging up one's ward looking for the fish delicacy. Alternatively, the fisherman/fisherwoman can resort to maintaining an earthworm colony.

Over the years people have invented and patented a number of devices to help draw earthworms to the surface, but most a electronic and require a probe and light. Such apparatus include those described in U.S. Pat. Nos.

Thus, there is a need in the art for a simple apparatus and method for surfacing earthworms from soil bearing earthworms.

### SUMMARY OF THE INVENTION

The present invention provides an apparatus including a hollow pipe or elongated member having a plurality of spaced apart notches disposed on one side of the pipe or member and a second member designed to be passed up and down across the notched surface producing sound and vibrations that when one end of the hollow pipe or member is placed against a site of a ground bearing earthworms causes the earthworms to surface (come to the surface) for harvesting.

The present invention also provides an apparatus including a hollow pipe or elongated member having a plurality of spaced apart notches disposed on one side of the pipe or member, a capped top end and an open bottom end and a second member designed to be passed up and down across the notched surface producing sound and vibrations when one end of the hollow pipe or member is placed against a site of a ground bearing earthworms causes the earthworms to surface (come to the surface) for harvesting.

The present invention provides an apparatus including a hollow pipe or elongated member having a plurality of spaced apart notches disposed on one side of the pipe or member, a capped top end and a capped bottom end and a second member designed to be passed up and down across the notched surface producing sound and vibrations when one end of the hollow pipe or member is placed against a site of a ground bearing earthworms causes the earthworms to surface (come to the surface) for harvesting.

The present invention also provides an apparatus including a hollow pipe or elongated member having a plurality of spaced apart notches disposed on one side of the pipe or member, an opened top end and a capped bottom end, where the cap includes an internal cavity including a ball bearing and a movable member extending from the internal cavity to an exterior of the cap and a second member designed to be passed up and down across the notched surface producing sound and vibrations when the moveable member of the capped end of the hollow pipe or member is placed against or pushed into a site of a ground bearing earthworms causes the earthworms to surface (come to the surface) for harvesting.

The present invention provides a method for harvesting earthworms including the step of placing a first end of an apparatus against a site of a ground bearing earthworms, passing the second member up and down over the notched side of the hollow member to generate vibrations in the ground bearing the earthworms until earthworms come to the surface, and harvesting the surfaced earthworms. The method can also include the step of fishing with the harvested earthworms.

### DESCRIPTION OF THE DRAWINGS

The invention can be better understood with reference to the following detailed description together with the appended illustrative drawings in which like elements are numbered the same:

FIG. 1A depicts a preferred embodiment of an earthworm surfacing apparatus of this invention including a hollow first member having a plurality of spaced apart triangular notches in one side thereof and a second member adapted to be passed up and down over the notches to produce vibrations;

FIG. 1B depicts another preferred embodiment of an earthworm surfacing apparatus of this invention including a hollow first member having a plurality of spaced apart oval or circular notches in one side thereof and a second member adapted to be passed up and down over the notches to produce vibrations;

FIG. 2A depicts another preferred embodiment of an earthworm surfacing apparatus of this invention including a hollow first member having a capped top end, a plurality of spaced apart triangular notches in one side thereof and a second member adapted to be passed up and down over the notches to produce vibrations;

FIG. 2B depicts another preferred embodiment of an earthworm surfacing apparatus of this invention including a hollow first member having a capped top end, a plurality of spaced apart oval or circular notches in one side thereof and a second member adapted to be passed up and down over the notches to produce vibrations;

FIG. 3A depicts another preferred embodiment of an earthworm surfacing apparatus of this invention including a hollow first member having capped top and bottom ends, a plurality of spaced apart triangular notches in one side thereof and a second member adapted to be passed up and down over the notches to produce vibrations;

FIG. 3B depicts another preferred embodiment of an earthworm surfacing apparatus of this invention including a hollow first member having capped top and bottom ends, a plurality of spaced apart oval or circular notches in one side thereof and a second member adapted to be passed up and down over the notches to produce vibrations;

FIG. 4A depicts another preferred embodiment of an earthworm surfacing apparatus of this invention including a hollow first member having capped top and bottom ends, a plurality of spaced apart triangular notches in one side thereof and a second member adapted to be passed up and down over the notches to produce vibrations;

FIG. 4B depicts another preferred embodiment of an earthworm surfacing apparatus of this invention including a hollow first member having capped top and bottom ends, a plurality of spaced apart triangular notches in one side thereof and a second member adapted to be passed up and down over the notches to produce vibrations;

FIG. 5A depicts another preferred embodiment of an earthworm surfacing apparatus of this invention including a hollow first member having capped top and bottom ends, a plurality of spaced apart triangular notches in one side thereof and a second member adapted to be passed up and down over the notches to produce vibrations;

FIG. 5B depicts another preferred embodiment of an earthworm surfacing apparatus of this invention including a hollow first member having capped top and bottom ends, a plurality of spaced apart triangular notches in one side thereof and a second member adapted to be passed up and down over the notches to produce vibrations; and

FIGS. 6A&B depict an electronic preferred embodiment of an earthworm surfacing apparatus of this invention including a housing having a handle, an battery unit, an ON/OFF switch and a vibration producing unit in electrical communication with the battery unit and the ON/OFF switch, where the vibration producing unit produces vibrations which emanate into an earthworm bearing soil where the apparatus is placed in contact with the ground.

### DETAILED DESCRIPTION OF THE INVENTION

The inventor has found that a simple apparatus and an effective method using the apparatus for raising earthworms to a surface of a ground bearing earthworms. The apparatus is designed to have one end of the apparatus placed in contact with a site of an earthworm bearing ground or soil. Once placed in contact with the ground, a member is passed up and down over a notched side of a hollow portion of the apparatus. This passing up and down over the notched side of the hollow portion of the apparatus causes vibrations to emanate in to the earthworm bearing ground causing the earthworms to come to a surface of the earthworm bearing ground for harvesting.

The present invention broadly relates to an apparatus including a hollow member having a plurality of spaced apart notches disposed on one side of the hollow member. The apparatus also includes a second member, which can be hollow or solid, preferably solid. The apparatus is designed to have one end placed against an earthworm bearing ground and the second member is designed to be rubbed up and down over the notched side of the hollow member producing ground vibrations of an amplitude and frequency sufficient to surface earthworms from the earthworm bearing ground.

The present invention broadly relates to a method for surfacing earthworm in an earthworm bearing soil including the steps of placing one end of the hollow member of this invention against a site of the earthworm bearing soil, rubbing the second member up and down across the notched side of the hollow member to produce vibrations emanating into the earthworm bearing soil, and harvesting the surfaced earthworms.

Suitable materials for use in the construction of the hollow member and the second member include, without limitation, metals, wood, plastics, composites, ceramics or mixtures or combinations thereof.

Suitable vibrating producing devices include, without limitation, air springs use a contained column of air inside an elastomeric bellows or sleeve to buffer cyclic motion, provide vibration isolation, or serve as a pneumatic actuator; impact hammers are used in structural and modal analysis to determine component or system response to impacts of varying amplitude and duration. A hammer with a force transducer in its head is paired with an accelerometer on the component being tested to compare impact and response; piezoelectric actuators are devices that produce a small displacement with a high force capability when voltage is applied; shakers are instruments that provide vibration, shock or modal excitation for testing and analysis; hydraulic rotary actuators and pneumatic rotary actuators use pressurized fluid such as air or hydraulic oil to rotate mechanical components; electric actuators with an output rod that provides linear motion via a motor driven ball screw, lead screw, or ACME screw assembly. The actuator's load is attached to the end of screw, or rod, and is often unsupported; electro hydraulic valve actuators and hydraulic valve actuators convert fluid pressure supply pressure into motion; electric rotary actuators drive components rotationally via electromagnetic power like a motor; linear actuators convert various forms of energy, such as air or hydraulic power, into linear mechanical motion; rodless linear actuators provide linear motion via a motor driven ball screw, acme screw, or belt drive assembly; other similar devices, and mixtures or combinations thereof.

The first member can be solid or hollow, but hollow is preferred. The first member can be between about 8 inches and about 36 inches in length, preferably, between about 10 inches and about 30 inches in length, particularly, between about 12 inches and 24 inches in length; although smaller and larger lengths are also within the scope of this invention. The first member can be about 1 inch to about 4 inches in diameter, preferably, between about 1.5 inches and about 3.5 inches, and particularly, between about 2 inches and about 3 inches in diameter; although smaller and larger diameters are also within in the scope of this invention. The second member can be solid or hollow, with solid being preferred. The second member can be between about 6 inches and about 24 inches in length, preferably about 6 inches to about 18 inches in diameter, and particularly, about 6 inches to about 12 inches; although smaller and larger lengths are also within the scope of this invention. The second member can be between about 0.5 inches and about 3 inches in diameter, preferably between about 0.5 and about 2 inches in diameter, and particularly, between about 1 and about 2 inches in diameter; although smaller and larger diameters are also within in the scope of this invention. The notches in the first side are separated by a gap between about 0.5 and about 2 inches, preferably, 0.5 and about 1.5 inches and particularly, between about 0.5 inches and about 1 inch; although smaller and larger gaps are within the scope of this invention. The notches can have a depth between about ⅛ to about ½ the diameter of the first member and preferably, between about ¼ and about ½ the diameter of the first member. The notches can also be of any desired shape such as triangular shaped, rectangular shaped, square shaped, circular shaped, oval shaped, parabolic shape, or any other convenient shape provided that the shape permits the second member to be rubbed across the notches producing vibrations that can emanate into the ground causing earthworms in an earthworm bearing soil to come to the surface.

By earthworm bearing soil, inventor means soil that is capable of supporting earthworms. Not all soil in all regions are capable of supporting earthworms. Generally, earthworms are found in soil that has sufficient moisture and nutrients to support earthworms. Such soils include garden soils, soils in wooded areas, especially, moist areas rich in decaying organic matter. However, the apparatus of this invention will work in any soil that can support earthworm.

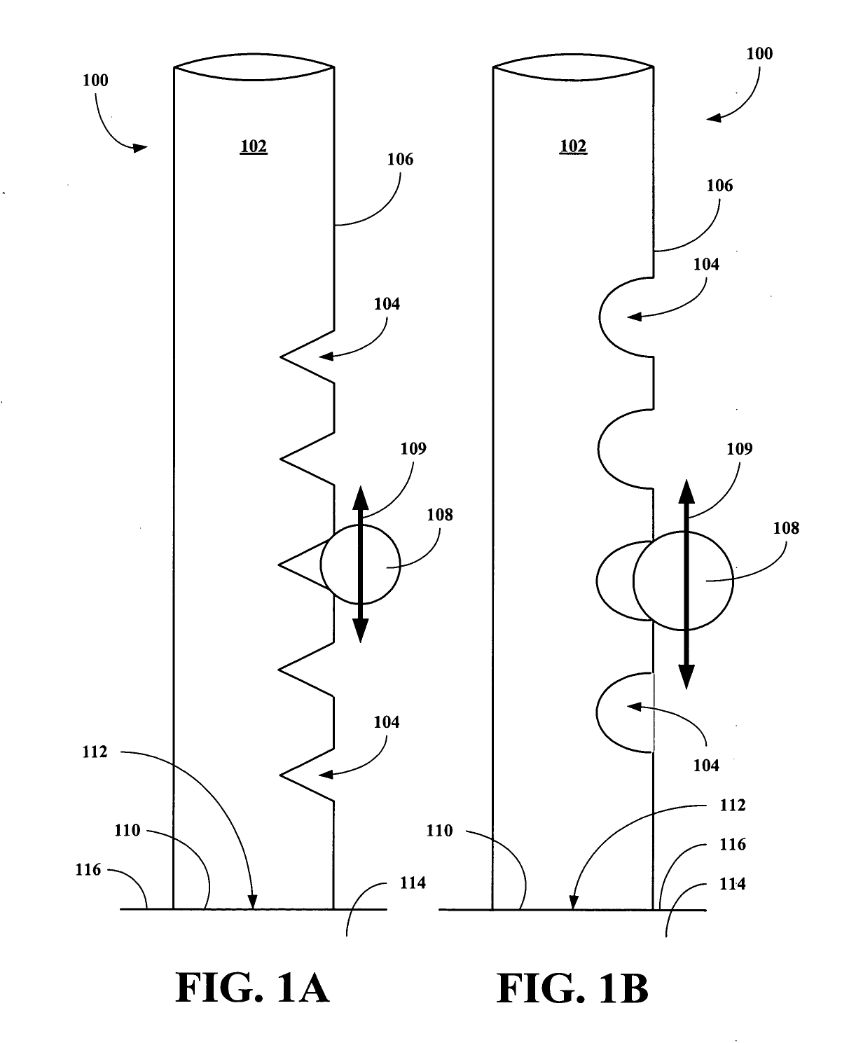

Referring now to FIG. 1A, an earthworm surfacing apparatus, generally 100, is shown to include a first member 102 having a plurality of spaced apart triangular shaped notches 104 disposed on a first side 106 of the first member 102. The apparatus 100 also includes a second member 108 adapted to be passed or rubbed up and down across (double sided arrow 109) the notched side 106 of the first member 102. When a bottom end 110 of the first member 102 is placed in contact with a site 112 of an earthworm bearing soil 114, then the action of rubbing the second member 108 across the notched side 106 of the first member 102 producing vibrations that emanate into the earthworm bearing soil 114 causing earthworms in the soil 114 to come to a surface 116 of the earthworm bearing soil 114.

Referring now to FIG. 1B, an earthworm surfacing apparatus, generally 100, is shown to include a first member 102 having a plurality of spaced apart oval or circular shaped notches 104 disposed on a first side 106 of the first member 102. The apparatus 100 also includes a second member 108 adapted to be passed or rubbed up and down across (double sided arrow 109) the notched side 106 of the first member 102. When a bottom end 110 of the first member 102 is placed in contact with a site 112 of an earthworm bearing soil 114, then the action of rubbing the second member 108 across the notched side 106 of the first member 102 producing vibrations that emanate into the earthworm bearing soil 114 causing earthworms in the soil 114 to come to a surface 116 of the earthworm bearing soil 114.

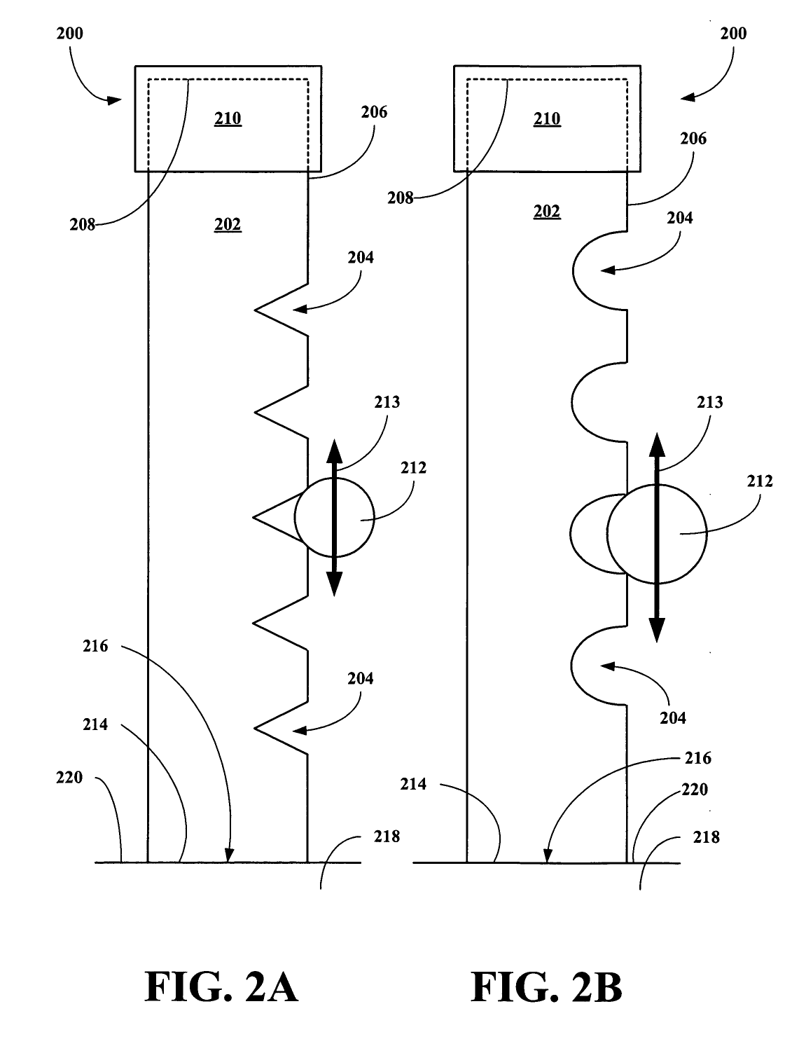

Referring now to FIG. 2A, an earthworm surfacing apparatus, generally 200, is shown to include a first member 202 having a plurality of spaced apart triangular shaped notches 204 disposed on a first side 206 of the first member 202 and a top end 208 having a cap 210. The apparatus 200 also includes a second member 212 adapted to be passed or rubbed up and down across (double sided arrow 213) the notched side 206 of the first member 202. When a bottom end 214 of the first member 202 is placed in contact with a site 216 of an earthworm bearing soil 218, then the action of rubbing the second member 212 across the notched side 206 of the first member 202 producing vibrations that emanate into the earthworm bearing soil 218 causing earthworms in the soil 218 to come to a surface 220 of the earthworm bearing soil 218. The top end 208 and the cap 210 can be threaded or can be smooth. The top end 208 and the cap 210 can include snap connections or any other device for maintaining the cap 210 on the top end 208.

Referring now to FIG. 2B, an earthworm surfacing apparatus, generally 200, is shown to include a first member 202 having a plurality of spaced apart oval or circular shaped notches 204 disposed on a first side 206 of the first member 202, and a top end 208 having a cap 210. The apparatus 200 also includes a second member 212 adapted to be passed or rubbed up and down across (double sided arrow 213) the notched side 206 of the first member 202. When a bottom end 214 of the first member 202 is placed in contact with a site 216 of an earthworm bearing soil 218, then the action of rubbing the second member 212 across the notched side 206 of the first member 202 producing vibrations that emanate into the earthworm bearing soil 218 causing earthworms in the soil 218 to come to a surface 220 of the earthworm bearing soil 218.

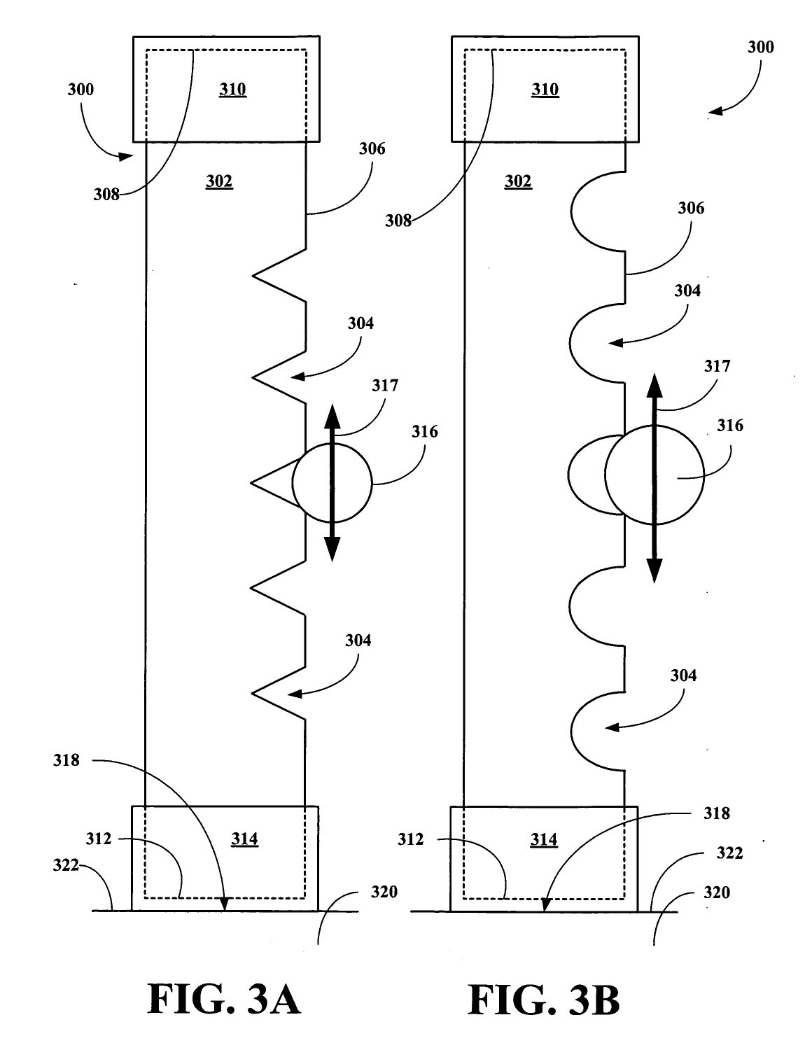

Referring now to FIG. 3A, an earthworm surfacing apparatus, generally 300, is shown to include a first member 302 having a plurality of spaced apart triangular shaped notches 304 disposed on a first side 306 of the first member 302, a top end 308 having a top end cap 310, and a bottom end 312 having a bottom end cap 314. The apparatus 300 also includes a second member 316 adapted to be passed or rubbed up and down across (double sided arrow 317) the notched side 306 of the first member 302. When the bottom end cap 314 of the first member 302 is placed in contact with a site 318 of an earthworm bearing soil 320, then the action of rubbing the second member 316 across the notched side 306 of the first member 302 producing vibrations that emanate into the earthworm bearing soil 320 causing earthworms in the soil 320 to come to a surface 322 of the earthworm bearing soil 320.

Referring now to FIG. 3B, an earthworm surfacing apparatus, generally 300, is shown to include a first member 302 having a plurality of spaced apart oval or circular shaped notches 304 disposed on a first side 306 of the first member 302, a top end 308 having a top end cap 310, and a bottom end 312 having a bottom end cap 314. The apparatus 300 also includes a second member 316 adapted to be passed or rubbed up and down across (double sided arrow 317) the notched side 306 of the first member 302. When the bottom end cap 314 of the first member 302 is placed in contact with a site 318 of an earthworm bearing soil 320, then the action of rubbing the second member 316 across the notched side 306 of the first member 302 producing vibrations that emanate into the earthworm bearing soil 320 causing earthworms in the soil 320 to come to a surface 322 of the earthworm bearing soil 320.

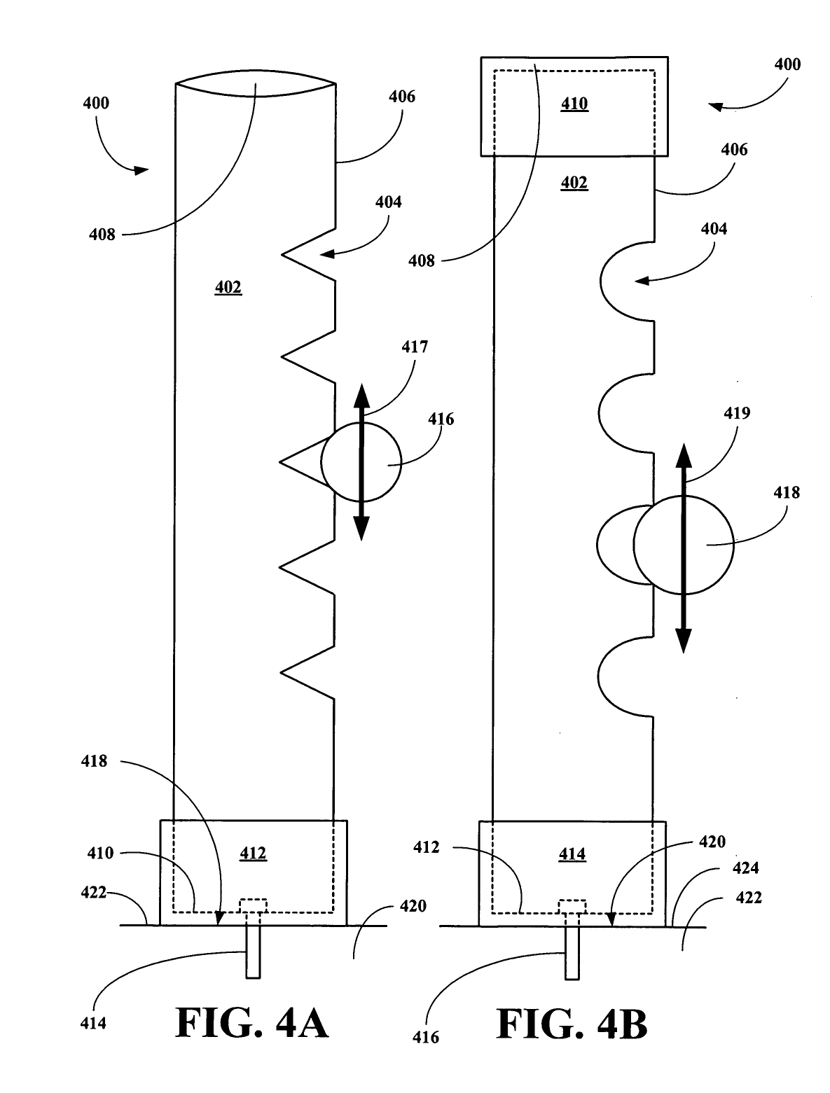

Referring now to FIG. 4A, an earthworm surfacing apparatus, generally 400, is shown to include a first member 402 having a plurality of spaced apart triangular shaped notches 404 disposed on a first side 406 of the first member 402, a top end 408, and a bottom end 410. The bottom end 410 includes a cap 412 having a protruding earth penetrating member 414 anchored into the cap 412. The apparatus 400 also includes a second member 416 adapted to be passed or rubbed up and down across (double sided arrow 417) the notched side 406 of the first member 402. After the earth penetrating member 414 of the bottom end cap 412 of the first member 402 is pushed into a site 418 of an earthworm bearing soil 420, the action of rubbing the second member 416 across the notched side 406 of the first member 402 producing vibrations that emanate into the earthworm bearing soil 420 causing earthworms in the soil 420 to come to a surface 422 of the earthworm bearing soil 420.

Referring now to FIG. 4B, an earthworm surfacing apparatus, generally 400, is shown to include a first member 402 having a plurality of spaced apart oval or circular shaped notches 404 disposed on a first side 406 of the first member 402, a top end 408 having a top end cap 410, and a bottom end 412 having a bottom end cap 414 including a protruding earth penetrating member 416 anchored into the cap 414. The apparatus 400 also includes a second member 418 adapted to be passed or rubbed up and down across (double sided arrow 419) the notched side 406 of the first member 402. After the earth penetrating member 416 of the bottom end cap 414 of the first member 402 is pushed into a site 420 of an earthworm bearing soil 422, the action of rubbing the second member 418 across the notched side 406 of the first member 402 producing vibrations that emanate into the earthworm bearing soil 422 causing earthworms in the soil 422 to come to a surface 424 of the earthworm bearing soil 422.

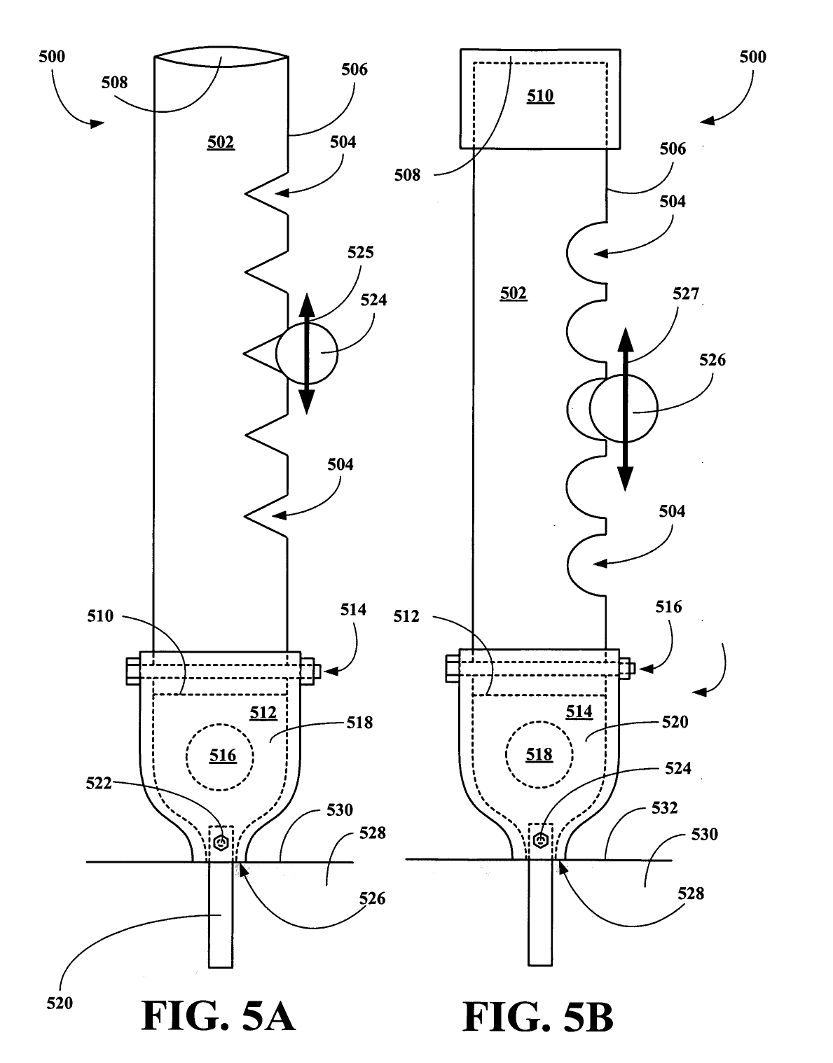

Referring now to FIG. 5A, an earthworm surfacing apparatus, generally 500, is shown to include a first member 502 having a plurality of spaced apart triangular shaped notches 504 disposed on a first side 506 of the first member 502, a top end 508, and a bottom end 510. The bottom end 510 includes a cap 512 attached to the bottom end 510 via a nut and bolt assembly 514 and having a ball bearing 516 disposed in an interior 518 thereof and a protruding earth penetrating member 520 anchored into the cap 512 via a second nut and bolt assembly 522. The apparatus 500 also includes a second member 524 adapted to be passed or rubbed up and down across (double sided arrow 525) the notched side 506 of the first member 502. After the earth penetrating member 520 of the bottom end cap 512 of the first member 502 is pushed into a site 526 of an earthworm bearing soil 528, the action of rubbing the second member 524 across the notched side 506 of the first member 502 producing vibrations that emanate into the earthworm bearing soil 528 causing earthworms in the soil 528 to come to a surface 530 of the earthworm bearing soil 528.

Referring now to FIG. 5B, an earthworm surfacing apparatus, generally 500, is shown to include a first member 502 having a plurality of spaced apart oval or circular shaped notches 504 disposed on a first side 506 of the first member 502, a top end 508 having a top end cap 510, and a bottom end 512 a cap 514 attached to the bottom end 512 via a nut and bolt assembly 516 and having a ball bearing 518 disposed in an interior 520 thereof and a protruding earth penetrating member 522 anchored into the bottom end cap 512 via a second nut and bolt assembly 524. The apparatus 500 also includes a second member 526 adapted to be passed or rubbed up and down across (double sided arrow 527) the notched side 506 of the first member 502. After the earth penetrating member 520 of the bottom end cap 512 of the first member 502 is pushed into a site 528 of an earthworm bearing soil 530, the action of rubbing the second member 526 across the notched side 506 of the first member 502 producing vibrations that emanate into the earthworm bearing soil 530 causing earthworms in the soil 530 to come to a surface 532 of the earthworm bearing soil 530.

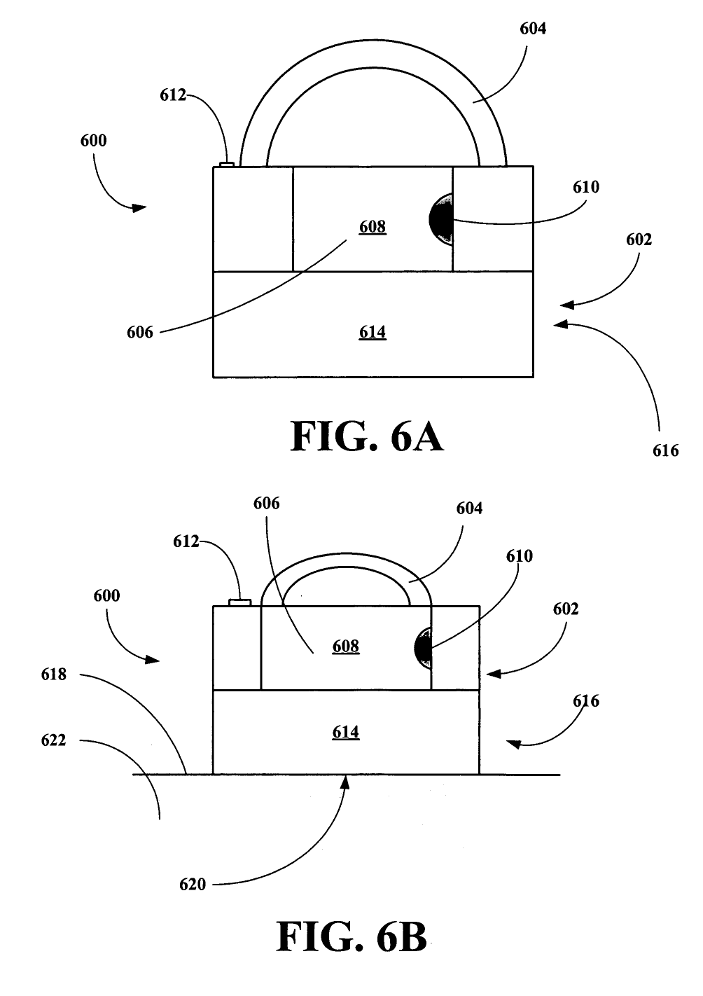

Referring now to FIG. 6A&B, an earthworm surfacing apparatus, generally 600, is shown to include a housing 602. The housing 602 includes a handle 604, a battery unit 606 having a door 608 including a thumb opening member 610. The housing 602 includes an ON/OFF switch 612 and a vibration producing unit 614 disposed in a bottom portion 616 of the housing 602.

The apparatus 600 is designed to be placed on a surface 618 of a site 620 of an earthworm bearing soil 622 as shown in FIG. 6B. Once placed on the site 620, the ON/OFF switch or button 612 is turned to its on position. The vibration producing unit 614 then produces vibrations that emanate into the soil 622 surfacing earthworms for harvesting.

All references cited herein are incorporated by reference. While this invention has been described fully and completely, it should be understood that, within the scope of the appended claims, the invention may be practiced otherwise than as specifically described. Although the invention has been disclosed with reference to its preferred embodiments, from reading this description those of skill in the art may appreciate changes and modification that maybe made which do not depart from the scope and spirit of the invention as described above and claimed hereafter.

I claim:

1. An apparatus comprising:
a first member including:
a top end,
a bottom end
a plurality of spaced apart notches disposed on one side of the elongated member and a second member,
where the bottom end of the first member is designed to placed against a site of an earthworm bearing soil and the second member designed to be passed up and down across the notched surface of the first member producing sound and vibrations that cause earthworms to surface from the earthworm bearing soil for harvesting.

2. The apparatus of claim 1, wherein the first member is hollow and elongate.

3. The apparatus of claim 1, wherein the second member is solid and elongate.

4. The apparatus of claim 1, further comprising:
a cap on the top end.

5. The apparatus of claim 1, further comprising:
a cap on the bottom end.

6. The apparatus of claim 1, further comprising:
a top end cap, and
a bottom end cap.

7. The apparatus of claim 1, wherein the ends and the end caps form threaded connections.

8. The apparatus of claim 1, further comprising:
an soil penetrating member protruding out from the bottom end cap.

9. The apparatus of claim 1, further comprising:
a bottom end cap including;
an interior cavity having a ball bearing disposed therein.

10. The apparatus of claim 1, further comprising:
a bottom end cap including;
an interior cavity having a ball bearing disposed therein, and
a soil penetrating member protruding out from the bottom end cap.

11. An apparatus comprising:
a housing including:
a handle;
a battery unit having a battery having
a door including a thumb opening member;
a vibration producing unit in electrical communication with the battery unit disposed in a bottom portion of the housing; and
an ON/OFF switch or button in electrical communication with the battery unit and the vibration producing unit;
where the apparatus is designed to placed against on a surface of a site of an earthworm bearing soil and to be turned on producing vibrations that cause earthworms to surface from the earthworm bearing soil for harvesting.

12. A method for harvesting earthworms comprising the steps of:
placing the bottom end of apparatus of claims 1 - 10 against a site of an earthworm bearing soil,
passing the second member up and down across the notched side of the first member to generate vibrations that emanate in the soil for a time sufficient for earthworms to come to the surface, and
harvesting the surfaced earthworms.

13. A method for harvesting earthworms comprising the steps of:
placing the bottom end of apparatus of claim 11 against a site of an earthworm bearing soil,
turning the apparatus ON for a time sufficient for earthworms to come to the surface, and harvesting the surfaced earthworms.
